(19) United States
(12) Patent Application Publication
(10) Pub. No.: US 2026/0302585 A1
(43) Pub. Date: Oct. 1, 2026

(54) COUPLER, BUTLER MATRIX CIRCUIT, TRANSMITTING CIRCUIT, AND TRANSMITTING DEVICE

(71) Applicant: SUMITOMO ELECTRIC INDUSTRIES, LTD., Osaka-shi, Osaka (JP)

(72) Inventor: Mikoto NAKAMURA, Osaka-shi, Osaka (JP)

(73) Assignee: SUMITOMO ELECTRIC INDUSTRIES, LTD., Osaka-shi, Osaka (JP)

(21) Appl. No.: 19/480,842

(22) PCT Filed: Apr. 30, 2024
(86) PCT No.: PCT/JP2024/016624

§ 371 Date: Nov. 3, 2025

(30) Foreign Application Priority Data
Jun. 12, 2023 (JP) 2023-095946

(51) Int. Cl. H01P 5/18; H01P 3/18; H01Q 3/40; H01Q 21/06

(52) U.S. Cl. CPC H01P 5/187; H01P 3/18; H01Q 3/40; H01Q 21/06

(57) ABSTRACT

This coupler is a coupling line-type coupler having a multilayer configuration in which a plurality of conductor layers are stacked, the coupler comprising first lines and a second line that are formed in the conductor layers different from one another, the first lines being formed in the plurality of conductor layers having interposed therebetween the conductor layer in which the second line is formed, and the first lines and the second line at least partially overlapping one another in the stacking direction of the conductor layers.

### TECHNICAL FIELD

The present disclosure relates to a coupler, a Butler matrix circuit, a transmitting circuit, and a transmitting device.

The present application claims priority under Japanese Patent Application No. 2023-95946, filed on Jun. 12, 2023, the entire contents of which are hereby incorporated by reference.

### BACKGROUND ART

PTL 1 (International Publication No. 2008/018565) discloses a high-frequency component such as that described below. In other words, a high-frequency component is a high-frequency component in which a high-frequency circuit including a high-frequency amplifier and an output matching circuit that receives high-frequency power output from the high-frequency amplifier is configured in a multilayer substrate formed by laminating a plurality of dielectric layers. The output matching circuit includes a first transmission line that propagates the high-frequency power from the high-frequency amplifier side toward an output terminal side. At least a portion of the first transmission line is formed by serially connecting, in a stacking direction, a plurality of conductor patterns formed across the plurality of dielectric layers.

### CITATION LIST

### Patent Literature

PTL 1: International Publication No. 2008/018565

### SUMMARY OF INVENTION

A coupler according to the present disclosure is a coupled-line coupler having a multilayer configuration in which a plurality of conductor layers are laminated. The coupler includes a first line and a second line formed in different ones of the conductor layers. The first line is formed in at least two of the conductor layers that sandwich at least one of the conductor layers in which the second line is formed. The first line and the second line at least partially overlap with each other in a lamination direction of the conductor layers.

### BRIEF DESCRIPTION OF DRAWINGS

FIG. 1 is an equivalent circuit diagram of a coupler according to an embodiment of the present disclosure.

FIG. 2 is a diagram schematically illustrating a configuration of the coupler according to the embodiment of the present disclosure.

FIG. 3 is a diagram schematically illustrating the configuration of the coupler according to the embodiment of the present disclosure.

FIG. 4 is a diagram schematically illustrating the configuration of the coupler according to the embodiment of the present disclosure.

FIG. 5 is a graph illustrating simulation results of transmission characteristics of the coupler according to the embodiment of the present disclosure.

FIG. 6 is a graph illustrating simulation results of the transmission characteristics of the coupler according to the embodiment of the present disclosure.

FIG. 7 is a graph illustrating simulation results of the transmission characteristics of the coupler according to the embodiment of the present disclosure.

FIG. 8 is a graph illustrating simulation results of phase characteristics of the coupler according to the embodiment of the present disclosure.

FIG. 9 is an equivalent circuit diagram of a coupler according to a first modification of the embodiment of the present disclosure.

FIG. 10 is a diagram schematically illustrating a configuration of the coupler according to the first modification of the embodiment of the present disclosure.

FIG. 11 is a diagram schematically illustrating the configuration of the coupler according to the first modification of the embodiment of the present disclosure.

FIG. 12 is a diagram schematically illustrating the configuration of the coupler according to the first modification of the embodiment of the present disclosure.

FIG. 13 is a graph illustrating simulation results of phase characteristics of a coupler according to a modification of the embodiment of the present disclosure.

FIG. 14 is a graph illustrating simulation results of amplitude characteristics of a coupler according to a modification of the embodiment of the present disclosure.

FIG. 15 is an equivalent circuit diagram of a coupler according to a second modification of the embodiment of the present disclosure.

FIG. 16 is a diagram schematically illustrating a configuration of the coupler according to the second modification of the embodiment of the present disclosure.

FIG. 17 is a diagram schematically illustrating the configuration of the coupler according to the second modification of the embodiment of the present disclosure.

FIG. 18 is a diagram schematically illustrating the configuration of the coupler according to the second modification of the embodiment of the present disclosure.

FIG. 19 is an equivalent circuit diagram of a coupler according to a third modification of the embodiment of the present disclosure.

FIG. 20 is a diagram schematically illustrating a configuration of the coupler according to the third modification of the embodiment of the present disclosure.

FIG. 21 is a diagram schematically illustrating the configuration of the coupler according to the third modification of the embodiment of the present disclosure.

FIG. 22 is a diagram schematically illustrating the configuration of the coupler according to the third modification of the embodiment of the present disclosure.

FIG. 23 is a diagram illustrating a configuration of a transmitting and receiving device according to the embodiment of the present disclosure.

FIG. 24 is a table illustrating an example of a beam direction of an RF signal transmitted by the transmitting and receiving device according to the embodiment of the present disclosure.

### DETAILED DESCRIPTION

In the related art, techniques for reducing the sizes of components, such as couplers, have been developed.

### Problems to be Solved by Present Disclosure

In electronic components such as Butler matrix circuits and Doherty amplifiers, branch-line type hybrid couplers are often used as couplers for equally distributing signals. However, in the case of a branch-line type hybrid coupler, the component size increases.

The present disclosure has been made to solve the above-described problem, and an object thereof is to provide a coupler, a Butler matrix circuit, a transmitting circuit, and a transmitting device capable of achieving a reduction in the size of an electronic component including the coupler.

### Advantageous Effects of Present Disclosure

According to the present disclosure, a reduction in the size of an electronic component including a coupler can be achieved.

### Description of Embodiments of the Present Disclosure

First, the contents of an embodiment of the present disclosure will be listed and described.
(1) A coupler according to an embodiment of the present disclosure is a coupled-line coupler having a multilayer configuration in which a plurality of conductor layers are laminated and includes a first line and a second line formed on different ones of the conductor layers. The first line is formed on at least two of the conductor layers sandwiching at least one of the conductor layers on which the second line is formed. The first line and the second line at least partially overlap with each other in a lamination direction of the conductor layers.

As described above, in the coupled-line coupler which is smaller in size than a branch-line coupler, with the configuration in which the first line is formed on at least two of the conductor layers sandwiching at least one of the conductor layers on which the second line is formed, even in the case where it is difficult, from a processing perspective, to bring the first line and the second line close to each other in the same conductor layer, the degree of coupling can be increased compared with a coupled-line coupler of the related art by utilizing the multilayer configuration. Thus, a small-sized coupler having a high degree of coupling can be achieved. Therefore, a reduction in the size of an electronic component including the coupler can be achieved.
(2) In (1) described above, the first line may have a first end connected to an input port in the coupler and a second end connected to an output port in the coupler, and the second line may have a first end connected to a coupling port in the coupler and a second end connected to an isolation port in the coupler.

With such a configuration, the amplitude error can be reduced compared with a configuration in which the second line is connected to the input port and the output port and in which the first line is connected to the coupling port and the isolation port.
(3) In (1) or (2) described above, the first line may be further formed on the at least one conductor layer on which the second line is formed.

With such a configuration, the degree of coupling of the coupler can be further increased.
(4) A Butler matrix circuit according to an embodiment of the present disclosure includes a plurality of coupled-line couplers formed on an identical substrate and each having a multilayer configuration in which a plurality of conductor layers are laminated. Each of the couplers includes a first line and a second line formed on different ones of the conductor layers, the first line being formed on at least two of the conductor layers sandwiching at least one of the conductor layers on which the second line is formed, and the first line and the second line at least partially overlap with each other in a lamination direction of the conductor layers. Each of the couplers includes an input port, an output port, a coupling port and an isolation port. The coupling port of the first coupler is connected to the input port of the third coupler. The coupling port of the second coupler is connected to the isolation port of the third coupler. The output port of the first coupler is connected to the input port of the fourth coupler. The output port of the second coupler is connected to the isolation port of the fourth coupler.

As described above, with the configuration that includes the plurality of coupled-line couplers, in each of which the first line is formed on at least two of the conductor layers sandwiching at least one of the conductor layers on which the second line is formed, the Butler matrix circuit can be configured using a small-sized coupler having a high degree of coupling. Thus, a small-sized Butler matrix circuit capable of equally distributing an input signal with higher accuracy can be achieved. Therefore, a reduction in the size of an electronic component including the coupler can be achieved.
(5) In (4) described above, the first line and the second line may intersect with each other in a lamination direction of the conductor layers.

With such a configuration, routing of wiring patterns for connecting the couplers becomes easier, thereby enabling further size reduction.
(6) A transmitting circuit according to an embodiment of the present disclosure is a transmitting circuit configured to be used for transmission of a signal in a frequency band of 20 GHz or more and includes the Butler matrix circuit according to (4) or (5) described above and a plurality of amplifiers mounted on the substrate. The plurality of amplifiers include a first amplifier configured to amplify a signal output from the coupling port of the third coupler, a second amplifier configured to amplify a signal output from the output port of the third coupler, a third amplifier configured to amplify a signal output from the coupling port of the fourth coupler, and a fourth amplifier configured to amplify a signal output from the output port of the fourth coupler.

With such a configuration, a high-frequency signal can be equally distributed with higher accuracy, amplified, and transmitted.
(7) A transmitting circuit according to an embodiment of the present disclosure is a transmitting device configured to be used for beamforming and includes the transmitting circuit according to (6) described above and a plurality of antennas. The plurality of antennas include a first antenna configured to transmit a signal amplified by the first amplifier, a second antenna configured to transmit a signal amplified by the second amplifier, a third antenna configured to transmit a signal amplified by the third amplifier, and a fourth antenna configured to transmit a signal amplified by the fourth amplifier.

With such a configuration, beamforming of a high-frequency signal can be performed with higher accuracy.

An embodiment of the present disclosure will be described below with reference to the drawings. Note that, in the drawings, the same or corresponding portions are denoted by the same reference signs, and descriptions thereof will not be repeated. In addition, at least parts of the embodiment described below may be freely combined.

### Coupler

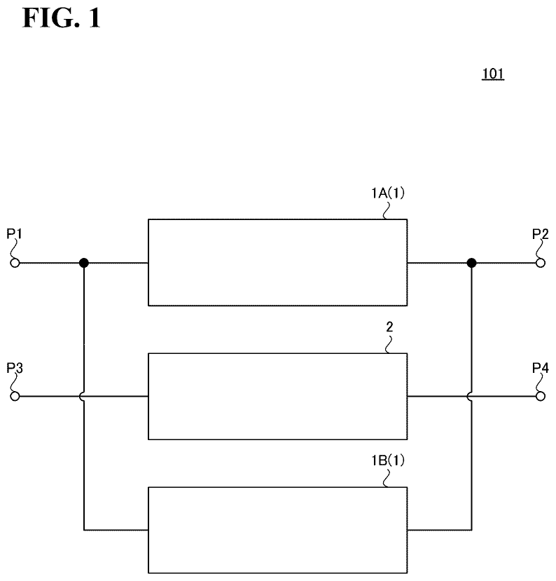

FIG. 1 is an equivalent circuit diagram of a coupler according to an embodiment of the present disclosure. Referring to FIG. 1, a coupler 101 includes main lines 1A and 1B, which are included in a main line 1, a sub-line 2, an input port P1, an output port P2, a coupling port P3, and an isolation port P4. For example, the input port P1, the output port P2, the coupling port P3, and the isolation port P4 may be terminals or may be nodes on a substrate. The main line 1 is an example of a first line. The sub-line 2 is an example of a second line.

Each of the main lines 1A and 1B has a first end and a second end that are respectively connected to the input port P1 and the output port P2. The sub-line 2 has a first end and a second end that are respectively connected to the coupling port P3 and the isolation port P4. For example, the main line 1 is a line that is connected in a DC manner to a transmission line of a main signal in an electronic component that includes the coupler 101. In other words, a main signal transmitted in the electronic component is input to the coupler 101 via the input port P1.

The coupler 101 is a hybrid coupler. More specifically, the coupler 101 receives an input signal S1 from the outside via the input port P1, outputs an output signal S2a via the output port P2, and outputs an output signal S2b via the coupling port P3. In this case, the phase of the output signal S2a is −90° with reference to the output signal S2b.

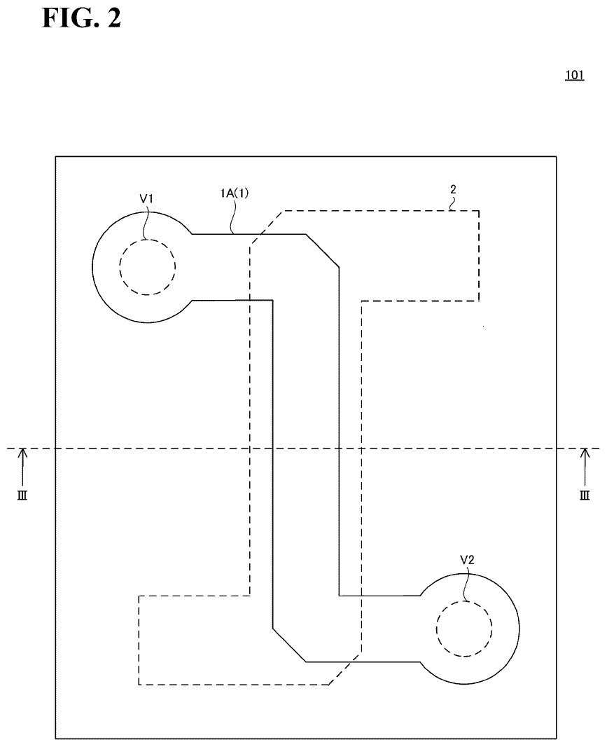

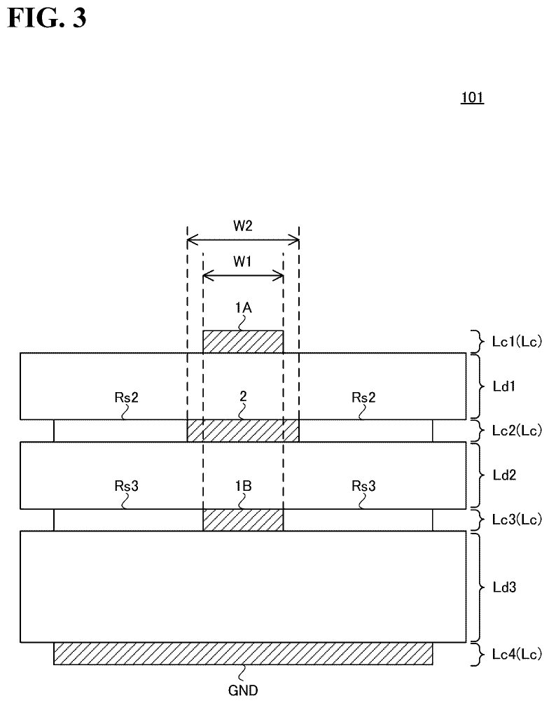

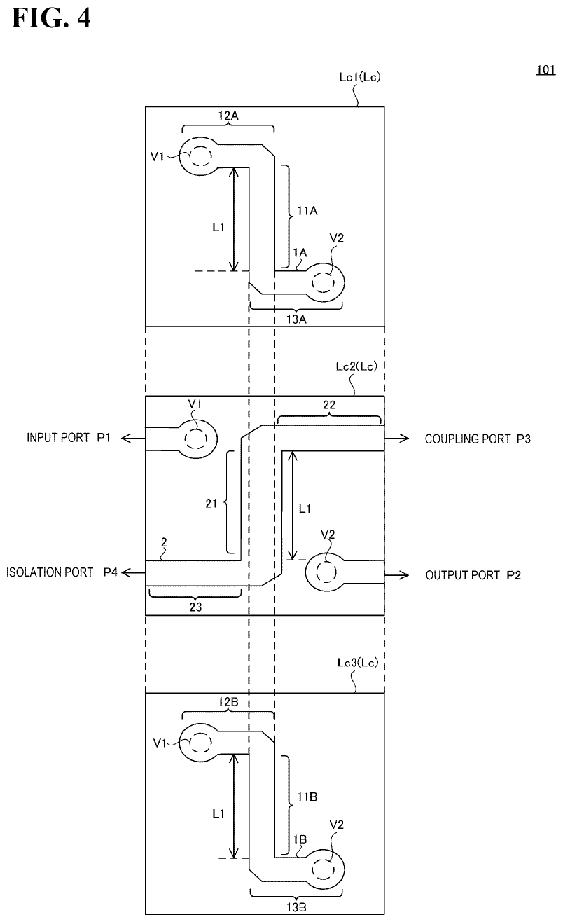

FIG. 2 to FIG. 4 are diagrams each schematically illustrating a configuration of the coupler according to the embodiment of the present disclosure. FIG. 2 is a plan view of the coupler 101. FIG. 3 is a sectional view taken along line III-III of FIG. 2. FIG. 4 is a plan view illustrating a layer configuration in the coupler 101. In FIG. 2, the solid line indicates the main line 1A. In FIG. 2, the dashed line indicates the sub-line 2.

Referring to FIG. 2 to FIG. 4, the coupler 101 is a coupled-line coupling device having a multilayer configuration in which a plurality of conductor layers Lc are laminated. More specifically, the coupler 101 includes conductor layers Lc1, Lc2, Lc3, and Lc4, which are the conductor layers Lc, and dielectric layers Ld1, Ld2, and Ld3.

The conductor layers Lc1, Lc2, Lc3, and Lc4 are laminated in this order with the dielectric layers Ld1, Ld2, and Ld3 interposed therebetween. More specifically, the conductor layer Lc4 is formed on a first surface that is one of the two main surfaces of the dielectric layer Ld3. The conductor layer Lc3 is formed on a second surface that is the other of the two main surfaces of the dielectric layer Ld3. The conductor layer Lc2 is formed on one of the two main surfaces of the dielectric layer Ld2, which is formed on the conductor layer Lc3, the one main surface being opposite to the other main surface facing the conductor layer Lc3. The conductor layer Lc1 is formed on one of the two main surfaces of the dielectric layer Ld1, which is formed on the conductor layer Lc2, the one main surface being opposite to the other main surface facing the conductor layer Lc2.

For example, the thickness of each of the dielectric layers Ld1 and Ld2 is 100 μm, and the thickness of the dielectric layer Ld3 is 200 μm. In addition, for example, the relative dielectric constant of each of the dielectric layers Ld1, Ld2, and Ld3 is 3.2. Furthermore, for example, the dielectric loss tangent of each of the dielectric layers Ld1, Ld2, and Ld3 is 0.004.

A ground pattern GND is formed on the conductor layer Lc4. The ground pattern GND is, for example, a thin copper-foil conductor formed in a solid pattern on one of the main surfaces of the dielectric layer Ld3. Note that, in the conductor layer Lc4, a resin member having the same thickness as the ground pattern GND may be provided in a region where the ground pattern GND is not formed, or a resin member that covers the ground pattern GND so as to protect a first main surface of the coupler 101 may be provided.

The main line 1 and the sub-line 2 are formed on different ones of the conductor layers Lc. More specifically, the sub-line 2 is formed on the conductor layer Lc2, while the main lines 1A and 1B are respectively formed on the conductor layers Lc1 and Lc3, with the conductor layer Lc2 sandwiched between the conductor layers Lc1 and Lc3. In a region of the conductor layer Lc2 where the sub-line 2 is not formed, a resin member Rs2 made of a dielectric material is provided. The resin member Rs2 functions as an adhesive bonding the dielectric layers Ld1 and Ld2 together. In a region of the conductor layer Lc3 where the main line 1B is not formed, a resin member Rs3 made of a dielectric material is provided. The resin member Rs3 functions as an adhesive bonding the dielectric layers Ld2 and Ld3 together. Note that, in the conductor layer Lc1, a resin member having the same thickness as the main line 1A may be provided in a region where the main line 1A is not formed, or a resin member that covers the main line 1A so as to protect a second main surface of the coupler 101 may be provided.

For example, the main line 1 and the sub-line 2 constitute a microstrip line together with the ground pattern GND. A width W1 of the main line 1 is smaller than a width W2 of the sub-line 2. As an example, for impedance adjustment of the lines, the width W1 and the width W2 are 200 μm and 320 μm, respectively. For example, the characteristic impedance of a line composed of the main lines 1A and 1B and the characteristic impedance of the sub-line 2 are each 50 Ω.

The main line 1A includes a linear coupling portion 11A, a wiring portion 12A extending from a first end of the coupling portion 11A, and a wiring portion 13A extending from a second end of the coupling portion 11A. The main line 1B includes a linear coupling portion 11B, a wiring portion 12B extending from a first end of the coupling portion 11B, and a wiring portion 13B extending from a second end of the coupling portion 11B. The sub-line 2 includes a linear coupling portion 21, a wiring portion 22 extending from a first end of the coupling portion 21, and a wiring portion 23 extending from a second end of the coupling portion 21. For example, the longitudinal directions of the coupling portions 11A, 11B, and 21 are parallel to each other. In addition, for example, a length L1 of each of the coupling portions 11A, 11B, and 21 is λ/4, where λ is the wavelength of the input signal S1.

The main lines 1A and 1B are electrically connected to each other through vias V1 and V2. More specifically, the wiring portions 12A and 12B of the main lines 1A and 1B are connected to each other through the via V1. In addition, the wiring portions 13A and 13B of the main lines 1A and 1B are connected to each other through the via V2.

The main line 1 and the sub-line 2 at least partially overlap each other in a lamination direction of the conductor layers Lc. More specifically, the coupling portions 11A and 11B of the main lines 1A and 1B overlap the coupling portion 21 when viewed in plan view. In other words, when the coupling portions 11A, 11B, and 21 are projected onto a plane perpendicular to the lamination direction of the conductor layers Lc, the projected coupling portions 11A and 11B overlap the projected coupling portion 21.

For example, the main line 1 and the sub-line 2 intersect with each other in the lamination direction of the conductor layers Lc. More specifically, in the lamination direction of the conductor layers Lc, an imaginary line connecting the first and second ends of the main line 1 and an imaginary line connecting the first and second ends of the sub-line 2 intersect with each other. In other words, when viewed in plan view, the imaginary line connecting the first and second ends of the main line 1 and the imaginary line connecting the first and second ends of the sub-line 2 intersect with each other. In addition, in the lamination direction of the conductor layers Lc, an imaginary line connecting the vias V1 and V2 intersects the sub-line 2. In other words, when viewed in plan view, the imaginary line connecting the vias V1 and V2 intersects the sub-line 2.

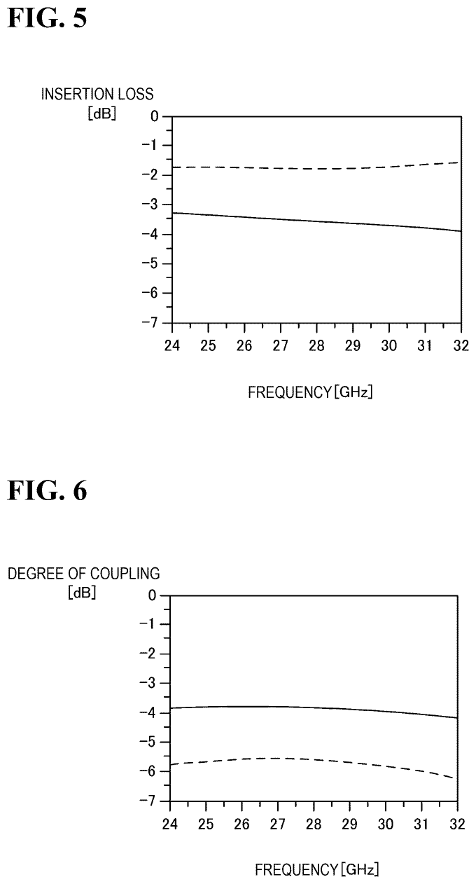

FIG. 5 to FIG. 7 are graphs each illustrating simulation results of transmission characteristics of the coupler according to the embodiment of the present disclosure. In FIG. 5 to FIG. 7, the solid line indicates the transmission characteristics of the coupler 101. In each of FIG. 5 to FIG. 7, the dashed line indicates the transmission characteristics of a coupler 101X according to a comparative example. In contrast to the coupler 101, the coupler 101X does not include either the conductor layer Lc3 or the dielectric layer Ld3, and the width of the main line 1A is 320 μm.

FIG. 5 illustrates the transmission characteristics from the input port P1 to the output port P2 of each of the couplers 101 and 101X. In FIG. 5, the horizontal axis denotes the frequency [GHz] of the input signal S1, and the vertical axis denotes the insertion loss [dB]. The insertion loss is the ratio of the power of the output signal S2a output via the output port P2 to the power of the input signal S1 when the input signal S1 is received via the input port P1. It is preferable that the insertion loss be a value close to −3 dB.

Referring to FIG. 5, in the frequency band from 24 GHz to 32 GHz, the insertion loss of the coupler 101 is closer to −3 dB than the insertion loss of the coupler 101X is.

FIG. 6 illustrates the transmission characteristics from the input port P1 to the coupling port P3 of each of the couplers 101 and 101X. In FIG. 6, the horizontal axis denotes the frequency [GHz] of the input signal S1, and the vertical axis denotes the degree of coupling [dB]. The degree of coupling is the ratio of the power of the output signal S2b output via the coupling port P3 to the power of the input signal S1 when the input signal S1 is received via the input port P1. It is preferable that the degree of coupling be a value close to −3 dB.

Referring to FIG. 6, in the frequency band from 24 GHz to 32 GHz, the degree of coupling of the coupler 101 is closer to −3 dB than the degree of coupling of the coupler 101X is.

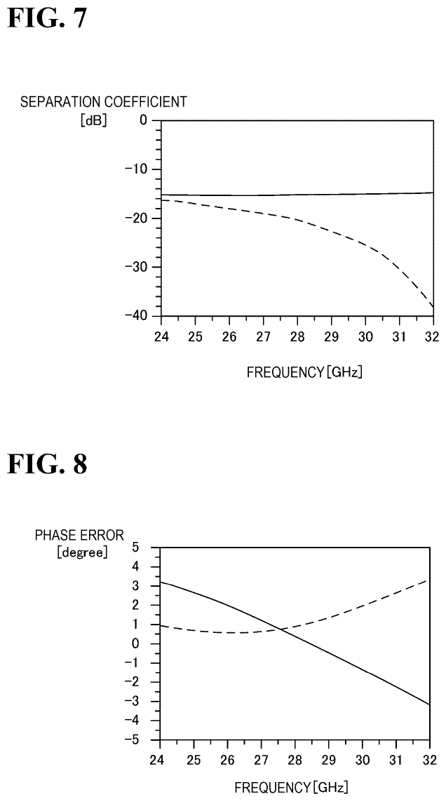

FIG. 7 illustrates the transmission characteristics from the input port P1 to the isolation port P4 of each of the couplers 101 and 101X. In FIG. 7, the horizontal axis denotes the frequency [GHz] of the input signal S1, and the vertical axis denotes the separation coefficient [dB]. The separation coefficient is the ratio of the power of an output signal output via the isolation port P4 to the power of the input signal S1 when the input signal S1 is received via the input port P1. It is preferable that the separation coefficient be −10 dB or less in practice.

Referring to FIG. 7, in the frequency band from 24 GHz to 32 GHz, the separation coefficient of the coupler 101 is about −15 dB, which falls within a practical range.

FIG. 8 is a graph illustrating simulation results of the phase characteristics of the coupler according to the embodiment of the present disclosure. In FIG. 8, the solid line indicates the phase characteristics of the coupler 101. In FIG. 8, the dashed line indicates the phase characteristics of the coupler 101X according to the comparative example. In FIG. 8, the horizontal axis denotes the frequency [GHz] of the input signal S1, and the vertical axis denotes the phase error [degree]. The phase error is a value obtained by adding 90° to the phase difference between the output signal S2a output via the output port P2 and the output signal S2b output via the coupling port P3. It is preferable that the phase error be 0°.

Referring to FIG. 8, in the frequency band from 24 GHz to 32 GHz, the maximum absolute value of the phase error of the coupler 101 is about 3°, which is comparable to the maximum absolute value of the phase error of the coupler 101X.

### First Modification

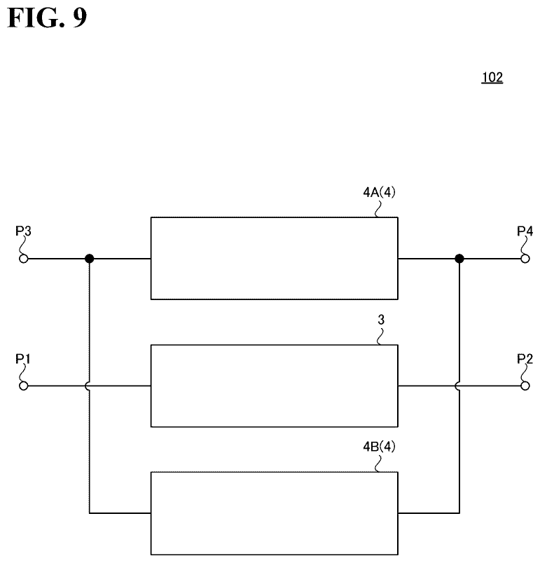

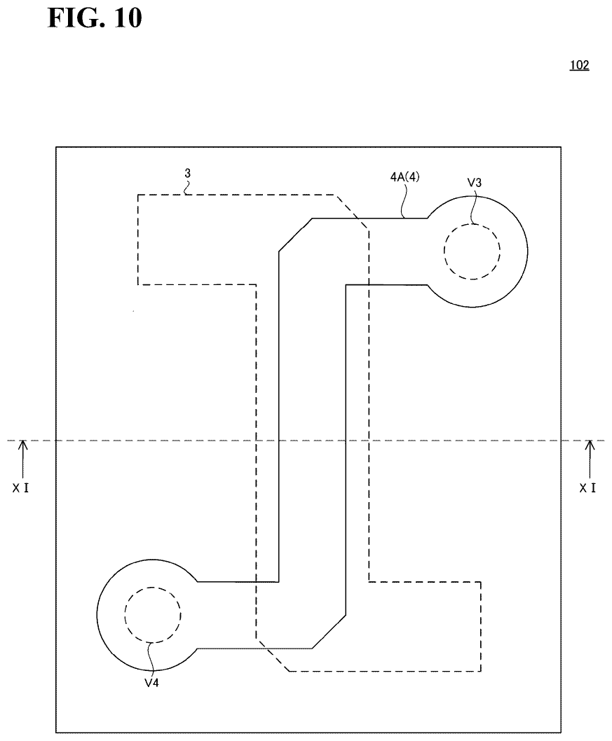

FIG. 9 is an equivalent circuit diagram of a coupler according to a first modification of the embodiment of the present disclosure. Referring to FIG. 9, in contrast to the coupler 101, the coupler 102 includes a main line 3 instead of the main line 1 and includes sub-lines 4A and 4B instead of the sub-line 2. The sub-lines 4A and 4B are included in a sub-line 4. The main line 3 is an example of the second line. The sub-line 4 is an example of the first line.

For example, the main line 3 has a first end and a second end that are respectively connected to the input port P1 and the output port P2. In addition, for example, each of the sub-lines 4A and 4B has a first end and a second end that are respectively connected to the coupling port P3 and the isolation port P4.

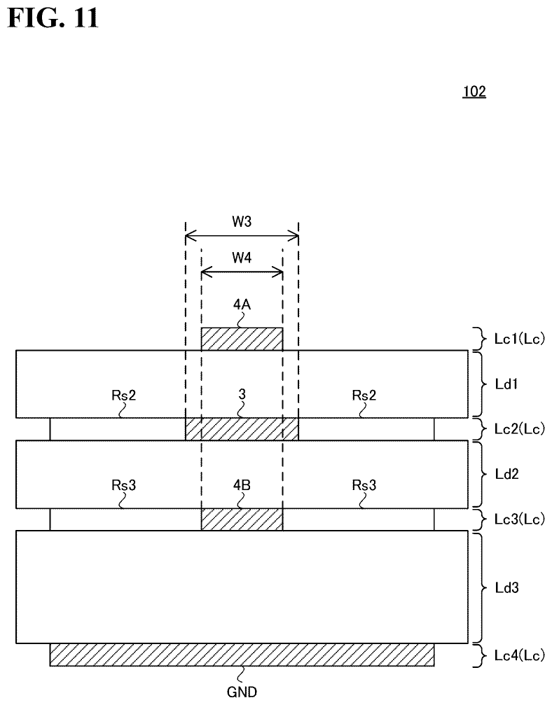

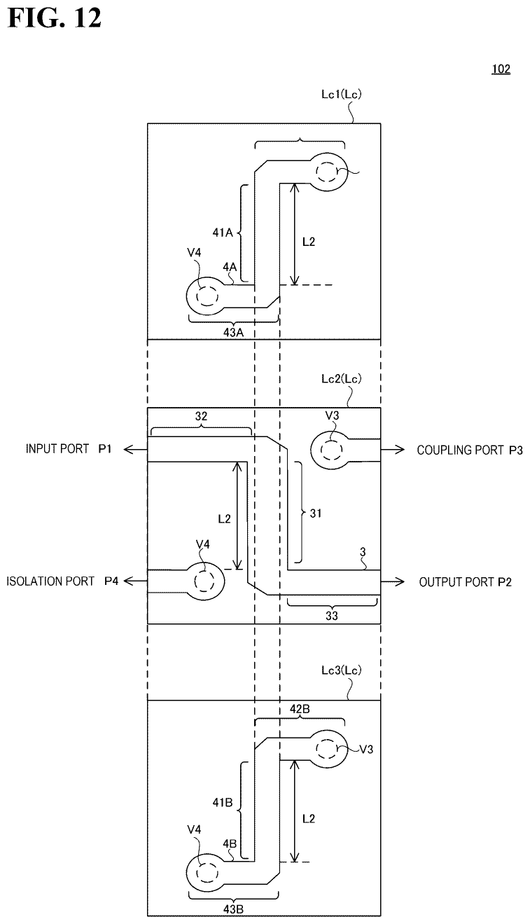

FIG. 10 to FIG. 12 are diagrams each schematically illustrating the configuration of the coupler according to the first modification of the embodiment of the present disclosure. FIG. 10 is a plan view of the coupler 102. FIG. 11 is a sectional view taken along line XI-XI of FIG. 10. FIG. 12 is a plan view illustrating a layer configuration in the coupler 102. In FIG. 10, the solid line indicates the sub-line 4A. In FIG. 10, the dashed line indicates the main line 3.

Referring to FIG. 10 to FIG. 12, in contrast to the coupler 101, in the coupler 102, the sub-line 4 is disposed at the position of the main line 1 in the lamination direction of the conductor layers Lc, and the main line 3 is disposed at the position of the sub-line 2 in the lamination direction of the conductor layers Lc. More specifically, the main line 3 is formed on the conductor layer Lc2, while the sub-lines 4A and 4B are respectively formed on the conductor layers Lc1 and Lc3, with the conductor layer Lc2 sandwiched between the conductor layers Lc1 and Lc3.

For example, the main line 3 and the sub-line 4 constitute a microstrip line. A width W4 of the sub-line 4 is smaller than a width W3 of the main line 3. As an example, the width W4 and the width W3 are 200 μm and 320 μm, respectively. For example, the characteristic impedance of the main line 3 and the characteristic impedance of a line composed of the sub-lines 4A and 4B are each 50 Ω.

The main line 3 includes a linear coupling portion 31, a wiring portion 32 extending from a first end of the coupling portion 31, and a wiring portion 33 extending from a second end of the coupling portion 31. The sub-line 4A includes a linear coupling portion 41A, a wiring portion 42A extending from a first end of the coupling portion 41A, and a wiring portion 43A extending from a second end of the coupling portion 41A. The sub-line 4B includes a linear coupling portion 41B, a wiring portion 42B extending from a first end of the coupling portion 41B, and a wiring portion 43B extending from a second end of the coupling portion 41B. For example, a length L2 of each of the coupling portions 31, 41A, and 41B is λ/4, where λ is the wavelength of the input signal S1.

The sub-lines 4A and 4B are electrically connected to each other through vias V3 and V4. More specifically, the wiring portions 42A and 42B of the sub-lines 4A and 4B are connected to each other through the via V3. In addition, the wiring portions 43A and 43B of the sub-lines 4A and 4B are connected to each other through the via V4.

The main line 3 and the sub-line 4 at least partially overlap each other in the lamination direction of the conductor layers Lc. More specifically, the coupling portions 41A and 41B of the sub-lines 4A and 4B are parallel to the coupling portion 31 of the main line 3 and overlap the coupling portion 31 when viewed in plan view.

For example, the main line 3 and the sub-line 4 intersect with each other in the lamination direction of the conductor layers Lc. More specifically, in the lamination direction of the conductor layers Lc, an imaginary line connecting the first and second ends of the sub-line 4 and an imaginary line connecting the first and second ends of the main line 3 intersect with each other. In addition, in the lamination direction of the conductor layers Lc, an imaginary line connecting the vias V3 and V4 intersects the main line 3.

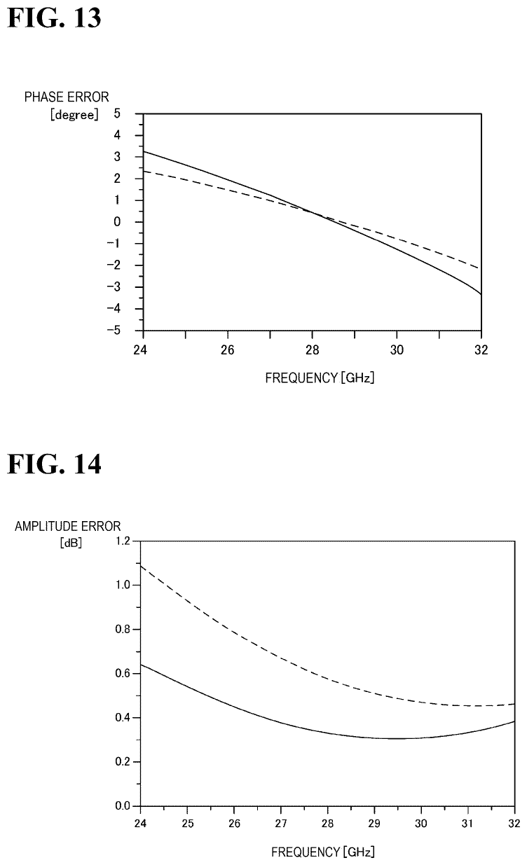

FIG. 13 is a graph illustrating simulation results of phase characteristics of a coupler according to a modification of the embodiment of the present disclosure. In FIG. 13, the solid line indicates the phase characteristics of the coupler 101. In FIG. 13, the dashed line indicates the phase characteristics of the coupler 102. In FIG. 13, the horizontal axis denotes the frequency [GHz] of the input signal S1, and the vertical axis denotes the phase error [degree].

Referring to FIG. 13, in the frequency band from 24 GHz to 32 GHz, the maximum absolute value of the phase error of the coupler 102 is about 2°, which is smaller than the maximum absolute value of the phase error of the coupler 101. Thus, the coupler 102 has better phase characteristics than the coupler 101.

FIG. 14 is a graph illustrating simulation results of amplitude characteristics of a coupler according to a modification of the embodiment of the present disclosure. In FIG. 14, the solid line indicates the amplitude characteristics of the coupler 101. In FIG. 14, the dashed line indicates the amplitude characteristics of the coupler 102. In FIG. 14, the horizontal axis denotes the frequency [GHz] of the input signal S1, and the vertical axis denotes the amplitude error [dB]. The amplitude error is an absolute value of the difference between the degree of coupling and the insertion loss. It is preferable that the amplitude error be 0 dB.

Referring to FIG. 14, in the frequency band from 24 GHz to 32 GHz, the amplitude error of the coupler 102 is larger than the amplitude error of the coupler 101 due to the influence of, for example, a transmission loss of the sub-line 4 in the vias V3 and V4. In particular, the amplitude error of the coupler 101 at 24 GHz is significantly smaller than the amplitude error of the coupler 102 at 24 GHz. Thus, the coupler 101 has better amplitude characteristics than the coupler 102.

The difference in phase characteristics between the couplers 101 and 102 is smaller than the difference in amplitude characteristics between the couplers 101 and 102. Thus, considering the phase characteristics and the amplitude characteristics comprehensively, the coupler 101 exhibits better performance than the coupler 102.

### Second Modification

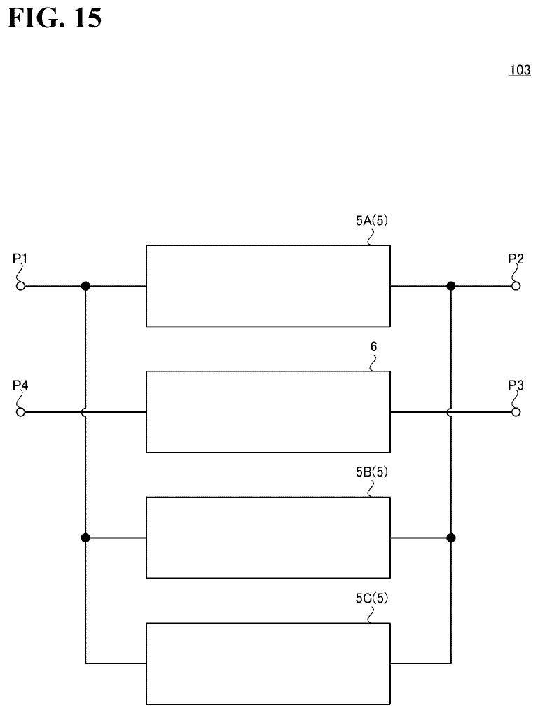

FIG. 15 is an equivalent circuit diagram of a coupler according to a second modification of the embodiment of the present disclosure. Referring to FIG. 15, in contrast to the coupler 101, the coupler 103 includes main lines 5A, 5B, and 5C, which are included in a main line 5, instead of the main line 1 and includes a sub-line 6 instead of the sub-line 2. The main line 5 is an example of the first line. The sub-line 6 is an example of the second line.

For example, the main line 5 has a first end and a second end that are respectively connected to the input port P1 and the output port P2. In addition, for example, the sub-line 6 has a first end and a second end that are respectively connected to the coupling port P3 and the isolation port P4.

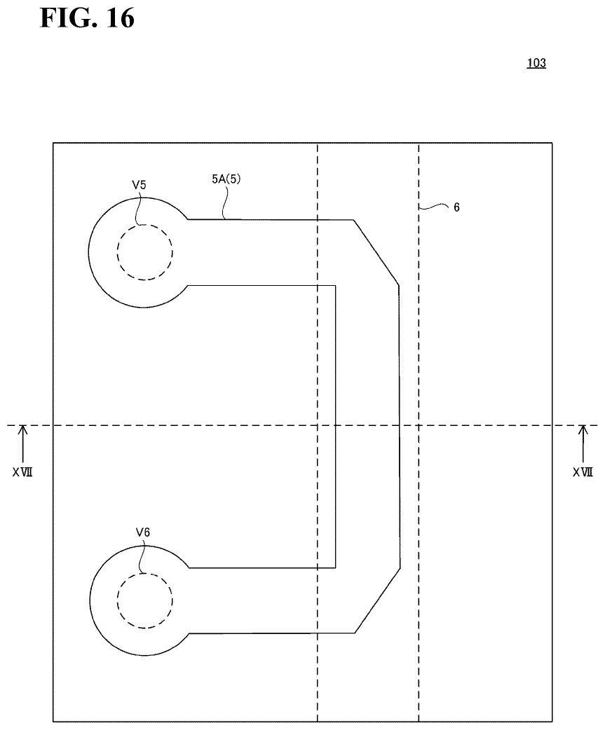

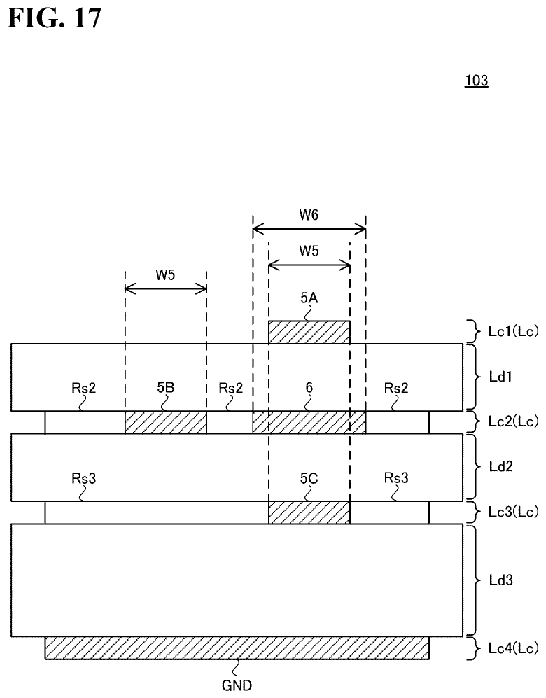

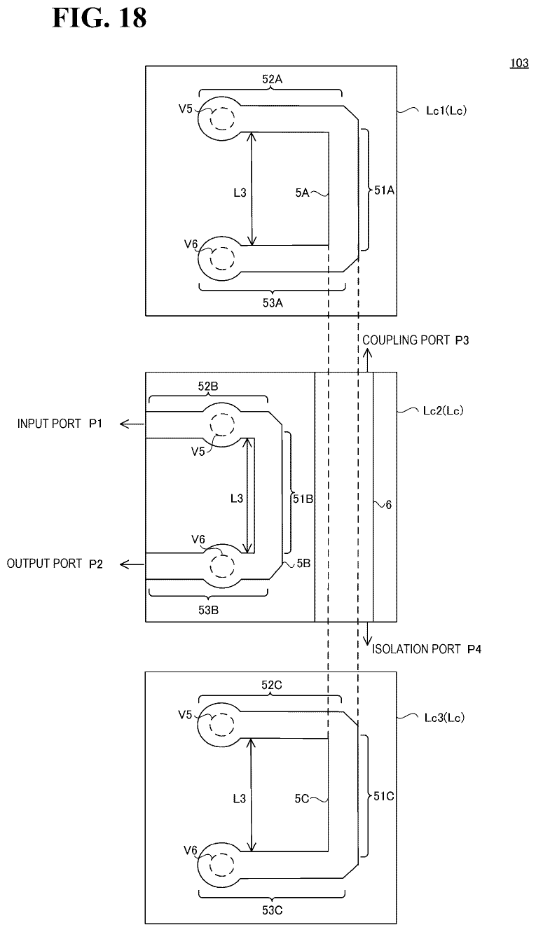

FIG. 16 to FIG. 18 are diagrams each schematically illustrating the configuration of the coupler according to the second modification of the embodiment of the present disclosure. FIG. 16 is a plan view of the coupler 103. FIG. 17 is a sectional view taken along line XVII-XVII of FIG. 16. FIG. 18 is a plan view illustrating a layer configuration in the coupler 103. In FIG. 16, the solid line indicates the main line 5A. In FIG. 16, the dashed line indicates the sub-line 6.

Referring to FIG. 16 to FIG. 18, the sub-line 6 is formed on the conductor layer Lc2, while the main lines 5A and 5C are respectively formed on the conductor layers Lc1 and Lc3, with the conductor layer Lc2 sandwiched between the conductor layers Lc1 and Lc3. The main line 5B is formed on the conductor layer Lc2. In a region of the conductor layer Lc2 where neither the sub-line 6 nor the main line 5B is formed, the resin member Rs2 is provided. In a region of the conductor layer Lc3 where the main line 5C is not formed, the resin member Rs3 is provided.

For example, the main line 5 and the sub-line 6 constitute a microstrip line. A width W5 of the main line 5 is smaller than a width W6 of the sub-line 6. For example, the characteristic impedance of a line composed of the main lines 5A, 5B, and 5C and the characteristic impedance of the sub-line 6 are each 50 Ω.

The main line 5A includes a linear coupling portion 51A, a wiring portion 52A extending from a first end of the coupling portion 51A, and a wiring portion 53A extending from a second end of the coupling portion 51A. The main line 5B includes a linear coupling portion 51B, a wiring portion 52B extending from a first end of the coupling portion 51B, and a wiring portion 53B extending from a second end of the coupling portion 51B. The main line 5C includes a linear coupling portion 51C, a wiring portion 52C extending from a first end of the coupling portion 51C, and a wiring portion 53C extending from a second end of the coupling portion 51C. For example, a length L3 of each of the coupling portions 51A, 51B, and 51C is λ/4, where λ is the wavelength of the input signal S1.

The main lines 5A, 5B, and 5C are electrically connected to each other through vias V5 and V6. More specifically, the wiring portions 52A, 52B, and 52C of the main lines 5A, 5B, and 5C are connected to each other through the via V5. In addition, the wiring portions 53A, 53B, and 53C of the main lines 5A, 5B, and 5C are connected to each other through the via V6.

The main line 5 and the sub-line 6 at least partially overlap each other in the lamination direction of the conductor layers Lc. More specifically, the coupling portions 51A and 51C of the main lines 5A and 5C are parallel to the sub-line 6 and overlap the sub-line 6 when viewed in plan view. In addition, the coupling portion 51B of the main line 5B is parallel to the sub-line 6. It is preferable that the distance between the coupling portion 51B and the sub-line 6 be as small as possible.

### Third Modification

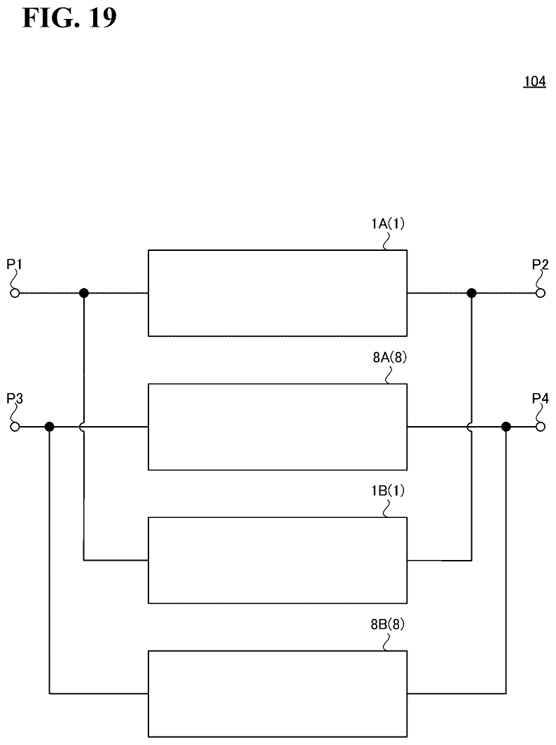

FIG. 19 is an equivalent circuit diagram of a coupler according to a third modification of the embodiment of the present disclosure. Referring to FIG. 19, in contrast to the coupler 101, a coupler 104 includes sub-lines 8A and 8B, which are included in a sub-line 8, instead of the sub-line 2. The sub-line 8 is an example of the second line.

For example, each of the sub-lines 8A and 8B has a first end and a second end that are respectively connected to the coupling port P3 and the isolation port P4.

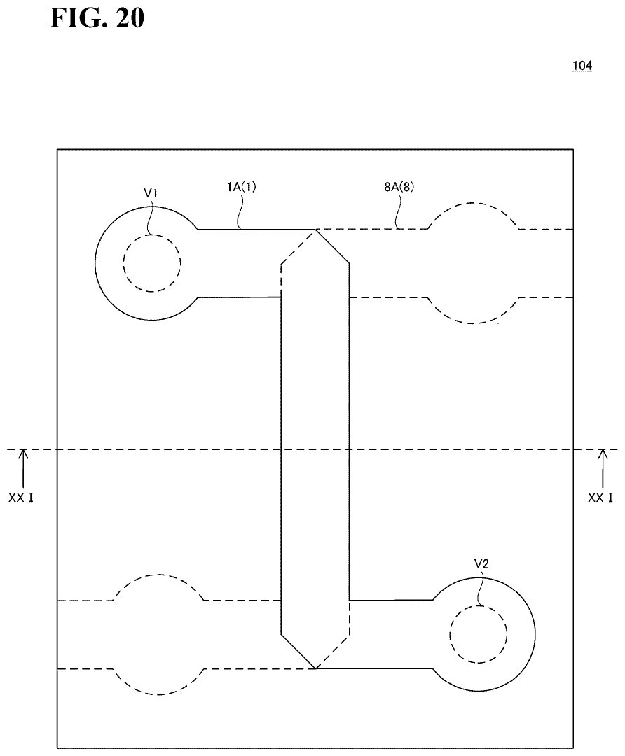

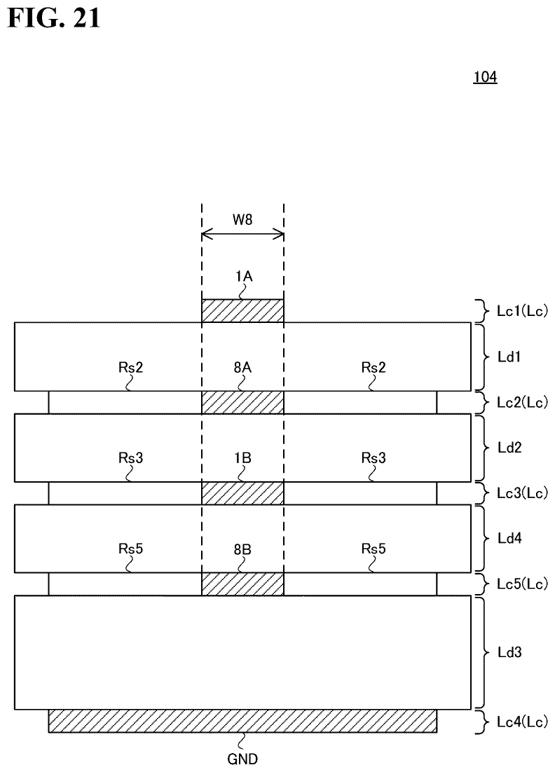

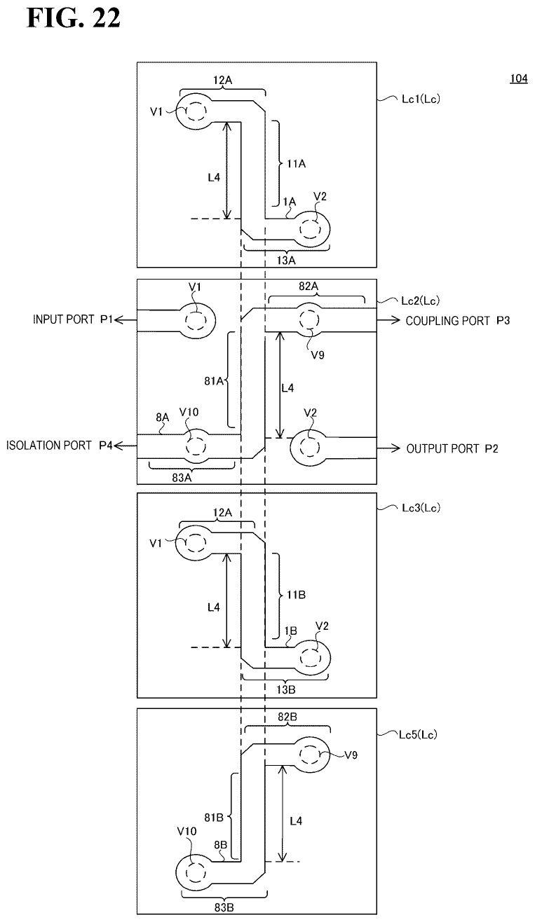

FIG. 20 to FIG. 22 are diagrams each schematically illustrating a configuration of the coupler according to the third modification of the embodiment of the present disclosure. FIG. 20 is a plan view of the coupler 104. FIG. 21 is a sectional view taken along line XXI-XXI of FIG. 20. FIG. 22 is a plan view illustrating a layer configuration in the coupler 104. In FIG. 20, the solid line indicates the main line 1A. In FIG. 20, the dashed line indicates the sub-line 8A.

In contrast to the coupler 101, the coupler 104 further includes a conductor layer Lc5, which is another conductor layer Lc, and a dielectric layer Ld4.

The conductor layers Lc1, Lc2, Lc3, Lc5, and Lc4 are laminated in this order with the dielectric layers Ld1, Ld2, Ld3, and Ld4 interposed therebetween. More specifically, the conductor layer Lc4 is formed on the first surface that is one of the two main surfaces of the dielectric layer Ld3. The conductor layer Lc5 is formed on the second surface that is the other of the two main surfaces of the dielectric layer Ld3. The conductor layer Lc3 is formed on one of the two main surfaces of the dielectric layer Ld4, which is formed on the conductor layer Lc5, the one main surface being opposite to the other main surface facing the conductor layer Lc5. The conductor layer Lc2 is formed on one of the two main surfaces of the dielectric layer Ld2, which is formed on the conductor layer Lc3, the one main surface being opposite to the other main surface facing the conductor layer Lc3. The conductor layer Lc1 is formed on one of the two main surfaces of the dielectric layer Ld1, which is formed on the conductor layer Lc2, the one main surface being opposite to the other main surface facing the conductor layer Lc2.

For example, the dielectric layer Ld4 has a thickness of 100 μm, a dielectric constant of 3.2, and a dielectric loss tangent of 0.004.

The main line 1 and the sub-line 8 are formed on different ones of the conductor layers Lc. More specifically, the sub-lines 8A and 8B are respectively formed on the conductor layers Lc2 and Lc5, while the main lines 1A and 1B are respectively formed on the conductor layers Lc1 and Lc3. In a region of the conductor layer Lc2 where the sub-line 8A is not formed, the resin member Rs2 is provided. In a region of the conductor layer Lc3 where the main line 1B is not formed, the resin member Rs3 is provided. The resin member Rs3 functions as an adhesive bonding the dielectric layers Ld2 and Ld4 together. In a region of the conductor layer Lc5 where the sub-line 8B is not formed, a resin member Rs5 made of a dielectric material is provided. The resin member Rs5 functions as an adhesive bonding the dielectric layers Ld4 and Ld3 together.

For example, the main line 1 and the sub-line 8 constitute a microstrip line. Each of the main line 1 and the sub-line 8 has a width W8 of, for example, 200 μm. For example, the characteristic impedance of a line composed of the main lines 1A and 1B and the characteristic impedance of a line composed of the sub-lines 8A and 8B are each 50 Ω.

The sub-line 8A includes a linear coupling portion 81A, a wiring portion 82A extending from a first end of the coupling portion 81A, and a wiring portion 83A extending from a second end of the coupling portion 81A. The sub-line 8B includes a linear coupling portion 81B, a wiring portion 82B extending from a first end of the coupling portion 81B, and a wiring portion 83B extending from a second end of the coupling portion 81B. For example, a length L4 of each of the coupling portions 11A, 11B, 81A, and 81B is λ/4, where λ is the wavelength of the input signal S1.

The sub-lines 8A and 8B are electrically connected to each other through vias V9 and V10. More specifically, the wiring portions 82A and 82B of the sub-lines 8A and 8B are connected to each other through the via V9. In addition, the wiring portions 83A and 83B of the sub-lines 8A and 8B are connected to each other through the via V10.

The main line 1 and the sub-line 8 at least partially overlap each other in the lamination direction of the conductor layers Lc. More specifically, the coupling portions 11A and 11B of the main lines 1A and 1B are parallel to the coupling portions 81A and 81B of the sub-lines 8A and 8B and overlap the coupling portions 81A and 81B when viewed in plan view.

For example, the main line 1 and the sub-line 8 intersect with each other in the lamination direction of the conductor layers Lc. More specifically, in the lamination direction of the conductor layers Lc, an imaginary line connecting the first and second ends of the main line 1 and an imaginary line connecting the first and second ends of the sub-line 8 intersect with each other. In addition, the imaginary line connecting the vias V1 and V2 intersects the sub-line 8. In addition, an imaginary line connecting the vias V9 and V10 intersects the main line 1.

The coupler 104 has been described as having a configuration in which the main line 1 is formed across two of the conductor layers Lc and in which the sub-line 8 is formed across two of the conductor layers Lc. However, the present disclosure is not limited to this. The coupler 104 may have a configuration in which the main line 1 is formed across three or more of the conductor layers Lc or may have a configuration in which the sub-line 8 is formed across three or more of the conductor layers Lc. More specifically, for example, the coupler 104 further includes a main line 1C as the main line 1. The main line 1C is formed on the conductor layer Lc that is located below the conductor layer Lc5 on which the sub-line 8B is formed. In addition, for example, the coupler 104 further includes a sub-line 8C as the sub-line 8. The sub-line 8C is formed on the conductor layer Lc that is located below the conductor layer Lc on which the main line 1C is formed.

### Transmitting and Receiving Device

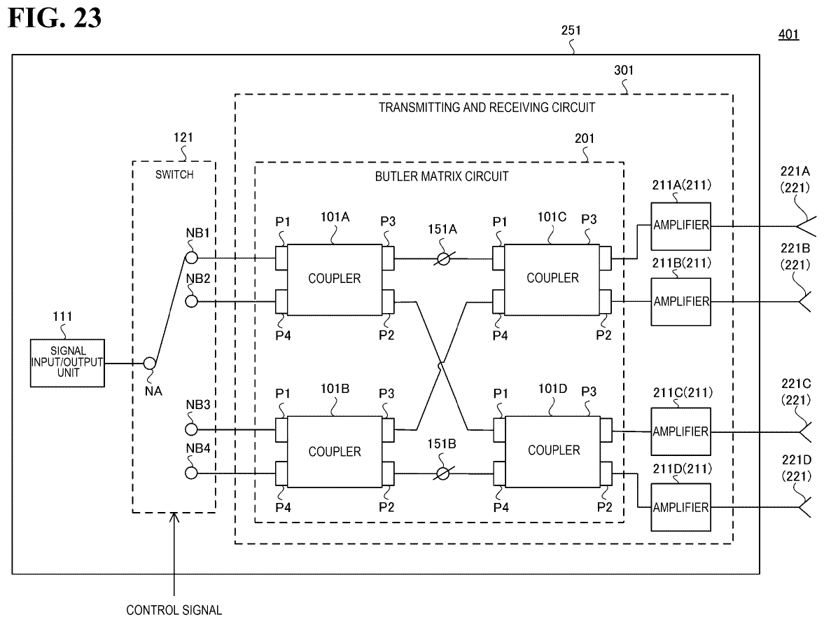

FIG. 23 is a diagram illustrating a configuration of a transmitting and receiving device according to the embodiment of the present disclosure. Referring to FIG. 23, a transmitting and receiving device 401 includes a signal input/output unit 111, a switch 121, a transmitting and receiving circuit 301, and antennas 221A, 221B, 221C, and 221D each of which is an antenna 221. The transmitting and receiving device 401 is an example of a transmitting device. The antennas 221A, 221B, 221C, and 221D are examples of a first antenna, a second antenna, a third antenna, and a fourth antenna, respectively. The transmitting and receiving device 401 is used for beamforming of radio frequency (RF) signals in a frequency band of 20 GHz or more.

The transmitting and receiving circuit 301 includes a Butler matrix circuit 201 and amplifiers 211A, 211B, 211C, and 211D each of which is a bidirectional amplifier 211. The transmitting and receiving circuit 301 is an example of a transmitting circuit. The amplifiers 211A, 211B, 211C, and 211D are examples of a first amplifier, a second amplifier, a third amplifier, and a fourth amplifier, respectively. The transmitting and receiving circuit 301 is used for transmission and reception of RF signals in a frequency band of 20 GHz or more.

The signal input/output unit 111, the switch 121, and the amplifiers 211 are mounted on a substrate 251. The Butler matrix circuit 201 is patterned on the substrate 251. For example, the antennas 221 are integrated with the substrate 251. The antenna 221 may be connected to the substrate 251 or may be patterned on the substrate 251.

The shape of each of the antennas 221 is, for example, a rectangular shape. When the wavelength of an RF signal transmitted and received by the transmitting and receiving circuit 301 is defined as λrf, the length of each of the antennas 221 is (0.15×λrf) to (0.7×λrf). The four antennas 221 may be arranged in a single row on a plane where the antennas 221 are arranged, or may be arranged in two rows and two columns on the plane. The antennas 221 are arranged at equal intervals, and each interval is (0.5×λrf) to λrf.

The Butler matrix circuit 201 includes a plurality of the couplers 101 and phase shifters 151A and 151B. For example, the Butler matrix circuit 201 includes the couplers 101A, 101B, 101C, and 101D each of which is the coupler 101. The couplers 101A, 101B, 101C, and 101D are examples of a first coupler, a second coupler, a third coupler, and a fourth coupler, respectively. The Butler matrix circuit 201 is a passive circuit implemented with a transmission line, and thus, it is lower in costs compared to an active phase shifter.

The input port P1 and the isolation port P4 of the coupler 101A are connected to nodes NB1 and NB2, respectively, in the switch 121. The input port P1 and the isolation port P4 of the coupler 101B are connected to nodes NB3 and NB4, respectively, in the switch 121. In the following description, each of the nodes NB1, NB2, NB3, and NB4 will also be referred to as “node NB”.

The signal input/output unit 111 is connected to a node NA in the switch 121. The switch 121 is a single-pole four-throw switch. The switch 121 receives a control signal from a control unit, which is not illustrated, and connects the node NA to one node NB among the four nodes NB in accordance with the received control signal.

The coupling port P3 of the coupler 101A is connected to the input port P1 of the coupler 101C via the phase shifter 151A. The output port P2 of the coupler 101A is connected to the input port P1 of the coupler 101D. The coupling port P3 of the coupler 101B is connected to the isolation port P4 of the coupler 101C. The output port P2 of the coupler 101B is connected to the isolation port P4 of the coupler 101D via the phase shifter 151B. Each of the phase shifters 151A and 151B receives an input signal and outputs a signal having a phase difference of −45° with respect to the received input signal.

The coupling port P3 and the output port P2 of the coupler 101C are connected to the amplifiers 211A and 211B, respectively. The coupling port P3 and the output port P2 of the coupler 101D are connected to the amplifier 211C and 211D, respectively.

The amplifiers 211A, 211B, 211C, and 211D are connected to the antennas 221A, 221B, 221C, and 221D, respectively. For example, each of the amplifiers 211 is a gallium nitride (GaN) device configured using a GaN transistor. A configuration in which a GaN device is used as an amplifying device enables transmission of RF signals at higher power.

In general, an active phase shifter is configured using a Si transistor, and thus, it cannot be integrated into the same semiconductor IC and surface-mount package as the amplifiers 211 each using a GaN device. This leads to the problem of higher costs. In contrast, since the transmitting and receiving circuit 301 is configured to include the Butler matrix circuit 201, which is a passive circuit, instead of an active phase shifter, the phase shifters and the amplifiers can be integrated on the substrate 251 at a lower cost compared to a configuration that includes an active phase shifter.

### Transmission of RF Signal

The signal input/output unit 111 receives an analog signal from a signal processing unit (not illustrated) and outputs an RF signal Sd based on the received analog signal to the Butler matrix circuit 201 via the switch 121.

The Butler matrix circuit 201 receives the RF signal Sd from the signal input/output unit 111 via the switch 121 and outputs RF signals Sout1, Sout2, Sout3, and Sout4 that are RF signals Sout based on the received RF signal Sd to the amplifiers 211A, 211B, 211C, and 211D, respectively. More specifically, the coupler 101C outputs the RF signal Sout1 to the amplifier 211A via the coupling port P3. The coupler 101C also outputs the RF signal Sout2 to the amplifier 211B via the output port P2. The coupler 101D outputs the RF signal Sout3 to the amplifier 211C via the coupling port P3. The coupler 101D also outputs the RF signal Sout4 to the amplifier 211D via the output port P2.

The amplifier 211A amplifies a signal output from the coupling port P3 of the coupler 101C. More specifically, the amplifier 211A receives the RF signal Sout1 from the coupling port P3 of the coupler 101C, amplifies the received RF signal Sout1, and outputs the amplified RF signal Sout1 to the antenna 221A.

The amplifier 211B amplifies a signal output from the output port P2 of the coupler 101C. More specifically, the amplifier 211B receives the RF signal Sout2 from the output port P2 of the coupler 101C, amplifies the received RF signal Sout2, and outputs the amplified RF signal Sout2 to the antenna 221B.

The amplifier 211C amplifies a signal output from the coupling port P3 of the coupler 101D. More specifically, the amplifier 211C receives the RF signal Sout3 from the coupling port P3 of the coupler 101D, amplifies the received RF signal Sout3, and outputs the amplified RF signal Sout3 to the antenna 221C.

The amplifier 211D amplifies a signal output from the output port P2 of the coupler 101D. More specifically, the amplifier 211D receives the RF signal Sout4 from the output port P2 of the coupler 101D, amplifies the received RF signal Sout4, and outputs the amplified RF signal Sout4 to the antenna 221D.

The antenna 221A transmits the signal amplified by the amplifier 211A. More specifically, the antenna 221A wirelessly transmits the RF signal Sout1 received from the amplifier 211A.

The antenna 221B transmits the signal amplified by the amplifier 211B. More specifically, the antenna 221B wirelessly transmits the RF signal Sout2 received from the amplifier 211B.

The antenna 221C transmits the signal amplified by the amplifier 211C. More specifically, the antenna 221C wirelessly transmits the RF signal Sout3 received from the amplifier 211C.

The antenna 221D transmits the signal amplified by the amplifier 211D. More specifically, the antenna 221D wirelessly transmits the RF signal Sout4 received from the amplifier 211D.

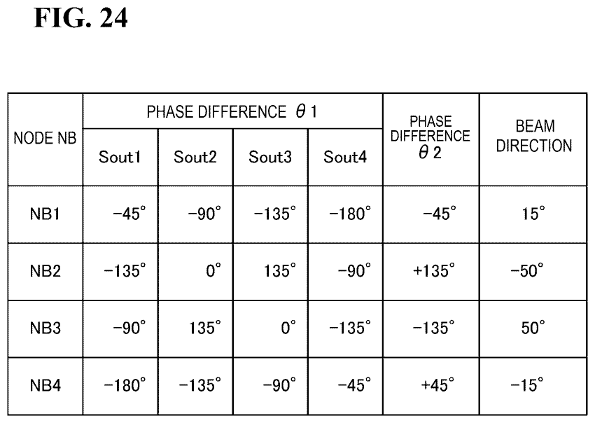

FIG. 24 is a table illustrating an example of a beam direction of an RF signal transmitted by the transmitting and receiving device according to the embodiment of the present disclosure. FIG. 24 illustrates correspondence relationships among the nodes NB each of which is to be connected to the node NA in the switch 121, phase differences θ1 of the RF signals Sout with respect to a predetermined phase, phase differences θ2 between the RF signals Sout, and the beam directions of the RF signals Sout transmitted by the antennas 221. The beam directions correspond to transmission directions of the RF signals Sout with respect to a predetermined direction.

Referring to FIG. 24, when the node NB1 is connected to the node NA in the switch 121, the RF signal Sout1 with the phase difference θ1 of −45°, the RF signal Sout2 with the phase difference θ1 of −90°, the RF signal Sout3 with the phase difference θ1 of −135°, and the RF signal Sout4 with the phase difference θ1 of −180° are output from the Butler matrix circuit 201 to the respective amplifiers 211. In this case, the phase difference θ2 is −45°, and the beam direction of the RF signals Sout transmitted by the antennas 221 is 15°.

When the node NB2 is connected to the node NA in the switch 121, the RF signal Sout1 with the phase difference θ1 of −135°, the RF signal Sout2 with the phase difference θ1 of 0°, the RF signal Sout3 with the phase difference θ1 of 135°, and the RF signal Sout4 with the phase difference θ1 of −90° are output from the Butler matrix circuit 201 to the respective amplifiers 211. In this case, the phase difference θ2 is +135°, and the beam direction of the RF signals Sout transmitted by the antennas 221 is −50°.

When the node NB3 is connected to the node NA in the switch 121, the RF signal Sout1 with the phase difference θ1 of −90°, the RF signal Sout2 with the phase difference θ1 of 135°, the RF signal Sout3 with the phase difference θ1 of 0°, and the RF signal Sout4 with the phase difference θ1 of −135° are output from the Butler matrix circuit 201 to the respective amplifiers 211. In this case, the phase difference θ2 is −135°, and the beam direction of the RF signals Sout transmitted by the antennas 221 is 50°.

When the node NB4 is connected to the node NA in the switch 121, the RF signal Sout1 with the phase difference θ1 of −180°, the RF signal Sout2 with the phase difference θ1 of −135°, the RF signal Sout3 with the phase difference θ1 of −90°, and the RF signal Sout4 with the phase difference θ1 of −45° are output from the Butler matrix circuit 201 to the respective amplifiers 211. In this case, the phase difference θ2 is +45°, and the beam direction of the RF signals Sout transmitted by the antennas 221 is −15°.

### Reception of RF Signal

The antennas 221 receive RF signals Sin and output the received RF signals Sin to the respective amplifiers 211. More specifically, the antenna 221A receives an RF signal Sin1, which is one of the RF signals Sin, and outputs the RF signal Sin1 to the amplifier 211A. The antenna 221B receives an RF signal Sin2, which is one of the RF signals Sin, and outputs the RF signal Sin2 to the amplifier 211B. The antenna 221C receives an RF signal Sin3, which is one of the RF signals Sin, and outputs the RF signal Sin3 to the amplifier 211C. The antenna 221D receives an RF signal Sin4, which is one of the RF signals Sin, and outputs the RF signal Sin4 to the amplifier 211D.

The amplifier 211A receives the RF signal Sin1 from the antenna 221A, amplifies the received RF signal Sin1, and outputs the amplified RF signal Sin1 to the coupling port P3 of the coupler 101C. The amplifier 211B receives the RF signal Sin2 from the antenna 221B, amplifies the received RF signal Sin2, and outputs the amplified RF signal Sin2 to the output port P2 of the coupler 101C. The amplifier 211C receives the RF signal Sin3 from the antenna 221C, amplifies the received RF signal Sin3, and outputs the amplified RF signal Sin3 to the coupling port P3 of the coupler 101D. The amplifier 211D receives the RF signal Sin4 from the antenna 221D, amplifies the received RF signal Sin4, and outputs the amplified RF signal Sin4 to the output port P2 of the coupler 101D.

The Butler matrix circuit 201 receives the RF signals Sin from the amplifiers 211 and, based on the received RF signals Sin, outputs RF signals Su to the signal input/output unit 111 via the switch 121. The signal input/output unit 111 outputs analog signals based on the RF signals Su received from the Butler matrix circuit 201 to a signal processing unit (not illustrated).

More specifically, in a state where the node NB1 in the switch 121 is connected to the node NA, the coupler 101A outputs, via the input port P1 and the switch 121, the RF signal Su, which is based on the RF signals Sin received by the respective antennas 221 from the beam direction of 15° and amplified by the respective amplifiers 211, to the signal input/output unit 111.

In addition, in a state where the node NB2 in the switch 121 is connected to the node NA, the coupler 101A outputs, via the isolation port P4 and the switch 121, the RF signal Su, which is based on the RF signals Sin received by the respective antennas 221 from the beam direction of −50° and amplified by the respective amplifiers 211, to the signal input/output unit 111.

In a state where the node NB3 in the switch 121 is connected to the node NA, the coupler 101B outputs, via the input port P1 and the switch 121, the RF signal Su, which is based on the RF signals Sin received by the respective antennas 221 from the beam direction of 50° and amplified by the respective amplifiers 211, to the signal input/output unit 111.

In addition, in a state where the node NB4 in the switch 121 is connected to the node NA, the coupler 101B outputs, via the isolation port P4 and the switch 121, the RF signal Su, which is based on the RF signals Sin received by the respective antennas 221 from the beam direction of −15° and amplified by the respective amplifiers 211, to the signal input/output unit 111.

Note that the coupler 101 according to the embodiment of the present disclosure may be used in a Doherty amplifier as an electronic component other than the Butler matrix circuit 201.

In the transmitting and receiving device 401 according to the embodiment of the present disclosure, although the transmitting and receiving circuit 301 is described as being configured to include the bidirectional amplifiers 211, it is not limited thereto. In the case where the transmitting and receiving device 401 performs time division duplex, the transmitting and receiving circuit 301 may be configured to include a unidirectional amplifier for transmission and a unidirectional amplifier for reception each of which operates in a time-division manner, instead of the amplifiers 211.

Although the transmitting and receiving device 401 according to the embodiment of the present disclosure is described as being configured to perform transmission and reception of RF signals, it is not limited thereto. The transmitting and receiving device 401 may be configured to perform transmission of RF signals without performing reception of RF signals. In this case, the transmitting and receiving device 401 includes a signal input unit that receives an analog signal from a signal processing unit (not illustrated) instead of the signal input/output unit 111. Alternatively, the transmitting and receiving device 401 may be configured to perform reception of RF signals without performing transmission of RF signals. In this case, the transmitting and receiving device 401 includes a signal output unit that outputs an analog signal to a signal processing unit (not illustrated) instead of the signal input/output unit 111.

Although the transmitting and receiving circuit 301 according to the embodiment of the present disclosure is described as being configured to perform transmission and reception of RF signals, it is not limited thereto. The transmitting and receiving circuit 301 may be configured to perform transmission of RF signals without performing reception of RF signals. In this case, the transmitting and receiving circuit 301 includes a unidirectional amplifier that amplifies the RF signals Sout, instead of the bidirectional amplifiers 211. Alternatively, the transmitting and receiving circuit 301 may be configured to perform reception of RF signals without performing transmission of RF signals. In this case, the transmitting and receiving circuit 301 includes a unidirectional amplifier that amplifies the RF signals Sin, instead of the bidirectional amplifiers 211.

In the transmitting and receiving circuit 301 according to the embodiment of the present disclosure, although the Butler matrix circuit 201 is described as being configured to include the couplers 101, it is not limited thereto. The Butler matrix circuit 201 may be configured to include the coupler 102 instead of the coupler 101, or may be configured to include the coupler 103, or may be configured to include the coupler 104.

The embodiments disclosed herein are to be considered in all respects as illustrative and not restrictive. The scope of the present invention is defined by the claims, rather than the above description, and is intended to include all variations within the scope of the claims and the meaning and the scope of their equivalents.

The above description includes features described in the following appendix.

### Appendix 1

A transmitting circuit configured to be used for transmission of a signal in a frequency band of 20 GHz or more, the transmitting circuit comprising:
a Butler matrix circuit including a plurality of coupled-line couplers formed on an identical substrate and each having a multilayer configuration in which a plurality of conductor layers are laminated; and
a plurality of amplifiers mounted on the substrate,
wherein each of the couplers includes a first line and a second line formed on different ones of the conductor layers, the first line being formed on at least two of the conductor layers sandwiching at least one of the conductor layers on which the second line is formed, and the first line and the second line at least partially overlap with each other in a lamination direction of the conductor layers,
wherein each of the couplers includes an input port, an output port, a coupling port and an isolation port,
wherein the coupling port of the first coupler is connected to the input port of the third coupler, and the coupling port of the second coupler is connected to the isolation port of the third coupler,
wherein the output port of the first coupler is connected to the input port of the fourth coupler, and the output port of the second coupler is connected to the isolation port of the fourth coupler,
wherein the plurality of amplifiers include a first amplifier configured to amplify a signal output from the coupling port of the third coupler, a second amplifier configured to amplify a signal output from the output port of the third coupler, a third amplifier configured to amplify a signal output from the coupling port of the fourth coupler, and a fourth amplifier configured to amplify a signal output from the output port of the fourth coupler, and
wherein each of the plurality of amplifiers is configured using a GaN transistor.

### REFERENCE SIGNS LIST

1, 1A, 1B, 3, 5, 5A, 5B, 5C main line
2, 4, 4A, 4B, 6, 8, 8A, 8B sub-line
11A, 11B, 21, 31, 41A, 41B, 51A, 51B, 51C, 81A, 81B coupling portion
12A, 12B, 13A, 13B, 22, 23, 32, 33, 42A, 42B, 43A, 43B, 52A, 52B, 52C, 53A,
53B, 53C, 82A, 82B, 83A, 83B wiring portion
101, 101A, 101B, 101C, 101D, 102, 103, 104 coupler
111 signal input/output unit
121 switch
151A, 151B phase shifter
201 Butler matrix circuit
211, 211A, 211B, 211C, 211D amplifier
221, 221A, 221B, 221C, 221D antenna
251 substrate
301 transmitting and receiving circuit
401 transmitting and receiving device
P1 input port
P2 output port
P3 coupling port
P4 isolation port
V1, V2, V3, V4, V5, V6, V9, V10 via
Lc, Lc1, Lc2, Lc3, Lc4, Lc5 conductor layer
Ld1, Ld2, Ld3, Ld4 dielectric layer
Rs2, Rs3, Rs5 resin member
GND ground pattern
NA, NB, NB1, NB2, NB3, NB4 node

1. A coupler being a coupled-line coupler having a multilayer configuration in which a plurality of conductor layers are laminated, the coupler comprising:
a first line and a second line formed on different ones of the conductor layers,
wherein the first line is formed on at least two of the conductor layers sandwiching at least one of the conductor layers on which the second line is formed, and
wherein the first line and the second line at least partially overlap with each other in a lamination direction of the conductor layers.

2. The coupler according to claim 1,
wherein the first line has a first end connected to an input port in the coupler and a second end connected to an output port in the coupler, and
wherein the second line has a first end connected to a coupling port in the coupler and a second end connected to an isolation port in the coupler.

3. The coupler according to claim 1,
wherein the first line is further formed on the at least one conductor layer on which the second line is formed.

4. A Butler matrix circuit comprising:
a plurality of coupled-line couplers formed on an identical substrate and each having a multilayer configuration in which a plurality of conductor layers are laminated,
wherein each of the couplers includes a first line and a second line formed on different ones of the conductor layers, the first line being formed on at least two of the conductor layers sandwiching at least one of the conductor layers on which the second line is formed, and the first line and the second line at least partially overlap with each other in a lamination direction of the conductor layers,
wherein each of the couplers includes an input port, an output port, a coupling port and an isolation port,
wherein the coupling port of the first coupler is connected to the input port of the third coupler,
wherein the coupling port of the second coupler is connected to the isolation port of the third coupler,
wherein the output port of the first coupler is connected to the input port of the fourth coupler, and
wherein the output port of the second coupler is connected to the isolation port of the fourth coupler.

5. The Butler matrix circuit according to claim 4,
wherein the first line and the second line intersect with each other in a lamination direction of the conductor layers.

6. A transmitting circuit configured to be used for transmission of a signal in a frequency band of 20 GHz or more, the transmitting circuit comprising:
the Butler matrix circuit according to claim 4; and
a plurality of amplifiers mounted on the substrate,
wherein the plurality of amplifiers include a first amplifier configured to amplify a signal output from the coupling port of the third coupler, a second amplifier configured to amplify a signal output from the output port of the third coupler, a third amplifier configured to amplify a signal output from the coupling port of the fourth coupler, and a fourth amplifier configured to amplify a signal output from the output port of the fourth coupler.

7. A transmitting device configured to be used for beamforming, the transmitting device comprising:
the transmitting circuit according to claim 6; and
a plurality of antennas,
wherein the plurality of antennas include a first antenna configured to transmit a signal amplified by the first amplifier, a second antenna configured to transmit a signal amplified by the second amplifier, a third antenna configured to transmit a signal amplified by the third amplifier, and a fourth antenna configured to transmit a signal amplified by the fourth amplifier.

8. The coupler according to claim 2,
wherein the first line is further formed on the at least one conductor layer on which the second line is formed.

9. A transmitting circuit configured to be used for transmission of a signal in a frequency band of 20 GHz or more, the transmitting circuit comprising:
the Butler matrix circuit according to claim 5; and
a plurality of amplifiers mounted on the substrate,
wherein the plurality of amplifiers include a first amplifier configured to amplify a signal output from the coupling port of the third coupler, a second amplifier configured to amplify a signal output from the output port of the third coupler, a third amplifier configured to amplify a signal output from the coupling port of the fourth coupler, and a fourth amplifier configured to amplify a signal output from the output port of the fourth coupler.
